(19) United States
(12) Patent Application Publication
(10) Pub. No.: US 2016/0157676 A1
(43) Pub. Date: Jun. 9, 2016

(54) Chafing dish with fitted food pan carrier ring

(71) Applicant: Agostino Difante, San Clemente, CA (US)

(72) Inventor: Agostino Difante, San Clemente, CA (US)

(21) Appl. No.: 14/544,163

(22) Filed: Dec. 4, 2014

(51) Int. Cl. A47J 39/02

(52) U.S. Cl. CPC A47J 39/02

(57) ABSTRACT

An apparatus for transporting hot food pans to a chafing dish, including a frame for holding a hot water pan, a hot water pan, a food pan carrier ring, a food pan and lid. The food pan carrier ring configured to overlay the rim of the hot water pan and configured to accept a food pan within the interior of the ring. The ring is capable of being vertically lifted to capture the food pan within the ring and transport the food pan to the chafing dish. The food pan and ring is inserted into the chafing dish. Later the ring is used to lift the food pan out of the chafing dish and transport it to the kitchen.

### BACKGROUND

The background of the invention will be discussed in two parts.

1. Field of Invention

The present invention relates in general to a fitted food pan carrier ring for transporting hot food in the food pan to a chafing dish, leaving the carrier in place in the chafing dish while the food is served and re-using the carrier to transport the empty pan back to the kitchen. More particularly to a ring for caring a hot food pan to a chafing dish eliminating the need to use gloves, rags or hot pads.

2. Prior Art

Apparatus for transporting hot food pans to a chafing dish are commonplace and a variety of such apparatus are known in the art, however, prior art devices are inefficient, and difficult to work. Existing food pans require the user to use gloves, hot pads, or towels to carry the food pan to the chafing dish. When they arrive at the chafing dish, while lowering the food pan into the chafing dish and holding the pan with pads, the pads are usually caught up under the food pan, and the user has to pull them out after setting the pan. When removing the pan, the user has to pry the pan up using his finger nail, or a butter knife and then use hot pads to carry the tray away. It is a feature of the present invention to provide a new and improved carrier to facilitate transporting hot food pans to the chafing dish at the buffet and later utilizing the same carrier to remove the food pan from the chafing dish. The improved carrier is more easy to use, more efficient, and safer than prior art devices. It is another feature of the invention to provide a carrier that can be used with existing food pans, eliminating the need to buy new food pans making the proposed invention a more economical solution. Other objects of the invention will become apparent with reading of the specification taken with the drawings wherein there is shown and described the apparatus of the invention.

### SUMMARY

The present invention provides a transportation apparatus for carrying hot food pans from the kitchen to the chafing dish, and from the chafing dish back to the kitchen. More specifically to a carrier ring designed to be placed under the food pan, while lifting the ring it catches the rim of the food pan. Resting it on the surface of the ring and holding it in place while it is transported to the desired location. The ring remains in place in the chafing dish. Later it is reused to carry the hot empty food pan back to the kitchen.

### DRAWINGS

FIG. 1 is an exploded perspective view of the food pan carrier and the complete chafing dish in accordance with the present invention;

FIG. 2 is a perspective view of the complete chafing dish with the food pan carrier installed.

FIG. 3a illustrates a perspective view of a handle for the food pan carrier.

FIG. 3b illustrates a perspective view of an alternative handle for the food pan carrier.

FIG. 3c illustrates a perspective view of an alternative handle for the food pan carrier.

FIG. 3d illustrates a perspective view of an alternative handle for the food pan carrier.

FIG. 4 is a top view perspective of the food pan carrier with the food pan installed in the carrier. It also shows how the food pan and carrier would be transported to the chafing dish location.

FIG. 5 is a top view perspective of the food pan carrier with the food pan and lid installed. It also shows how the complete set would be transported to the chafing dish location.

FIG. 6 is a top plan view of the food pan carrier.

FIG. 7 is a perspective view of the food pan carrier.

### DESCRIPTION

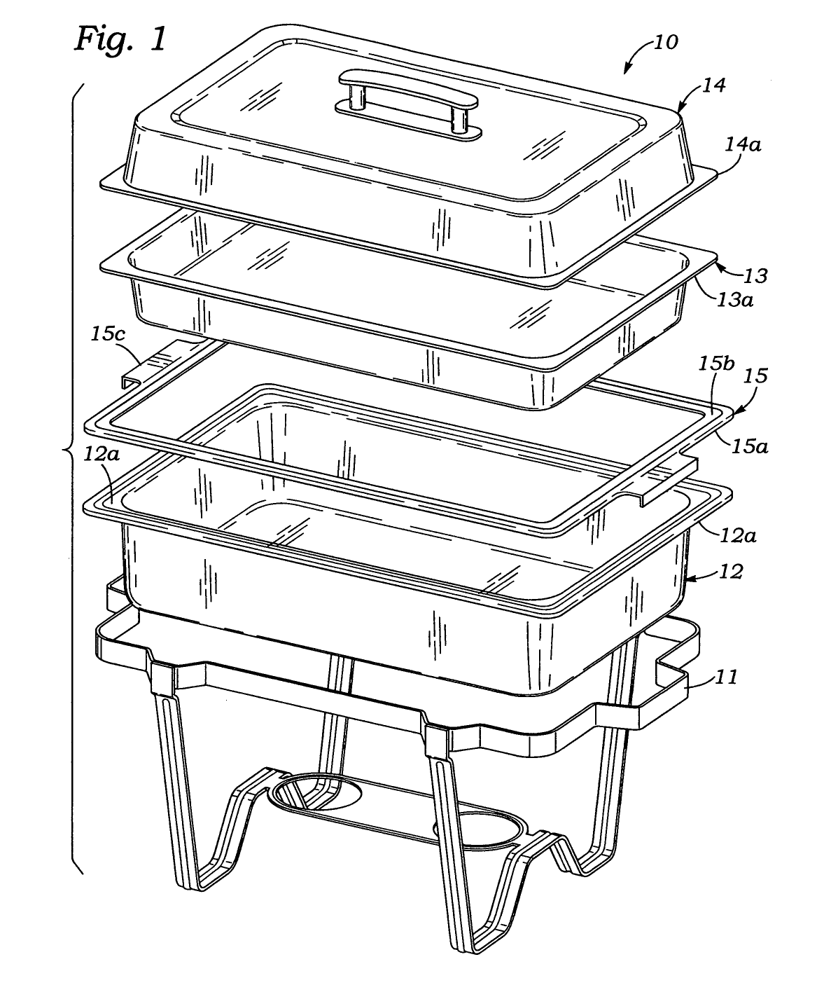

Referring now to the drawings in general, and particularly to FIG. 1, there is shown an exploded view of the chafing dish assembly generally designated 10. The chafing dish assembly 10 includes a prior art frame 11, a prior art hot water pan 12, a prior art food pan 13, and a prior art lid 14. Included in FIG. 1 is the proposed invention for a fitted food pan carrier ring 15. The fitted food carrier ring 15 and its profile 15a and 15b is generally configured to match the profile of the rim 12a of the hot water pan. Generally matching the profile 12a of the hot water pan allows the food pan carrier ring 15 and profile 15a to fit snuggly over the rim 12a of the hot water pan. It also allows for the food pan 13 and rim 13a to fit snuggly on top of the rim 15b of the food pan carrier ring 15. In addition it is shown that because the food carrier ring rim 15b is configured to generally match hot water pan rim 12a, it allows the rim 14a of the lid to snuggly fit the rim of the food carrier rim 15b. Also shown are two handles 15c of the food pan carrier 15.

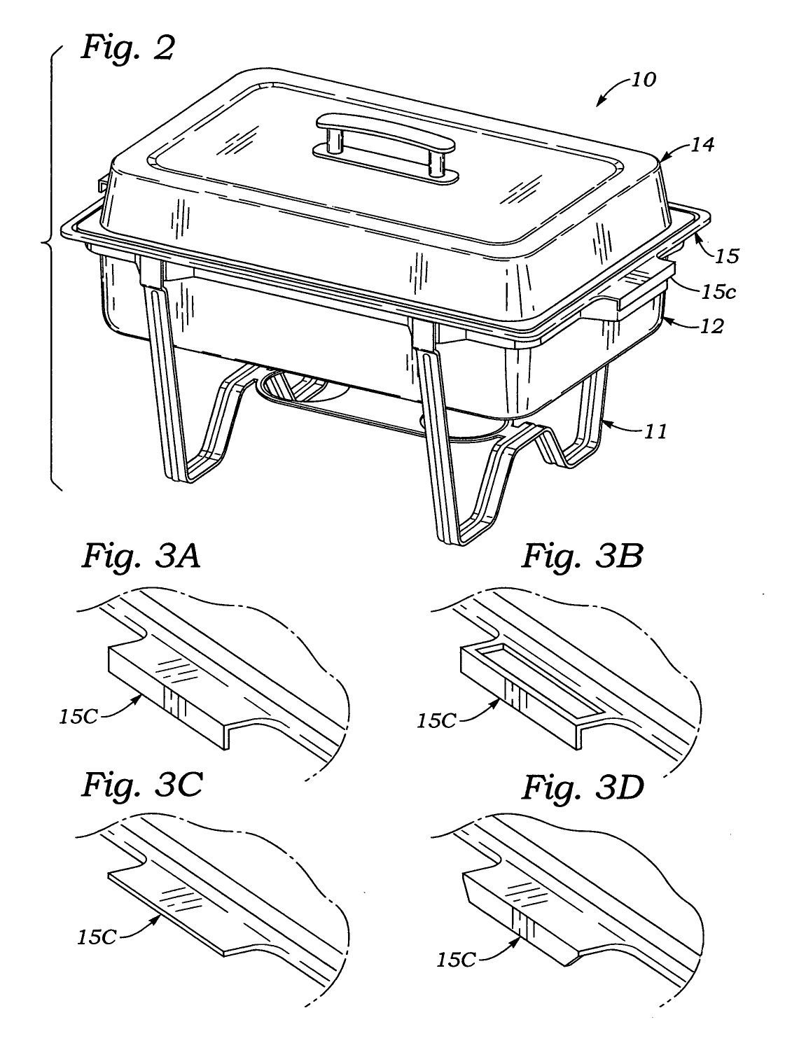

FIG. 2 illustrates the complete chafing dish generally designated 10 with the frame 11, the hot water pan 12, the food pan carrier ring 15, the food pan 13, and the lid 14 in the assembled position. Here is shown how the rims of the various parts, the hot water pan rim 12a, the food pan carrier ring rim 15a, the food pan rim 13, and the lid rim 14a fit together allowing the chafing dish to assemble together as if food pan carrier ring 15 was originally part of the assembly.

FIG. 3a illustrates in possible configuration for the food pan carrier handles 15c. Here is also shown how the handles 15c can be integral with the food pan carrier ring 15.

FIG. 3b illustrates another possible alternative for the food carrier handles 15c. Here is also shown how the handles 15c can be integral with the food pan carrier ring 15.

FIG. 3c illustrates another possible alternative for the food carrier handles 15c. Here is also shown how the handles 15c can be integral with the food pan carrier ring 15.

FIG. 3d illustrates another possible alternative for the food carrier handles 15c. Here is also shown how the handles 15c can be integral with the food pan carrier ring 15.

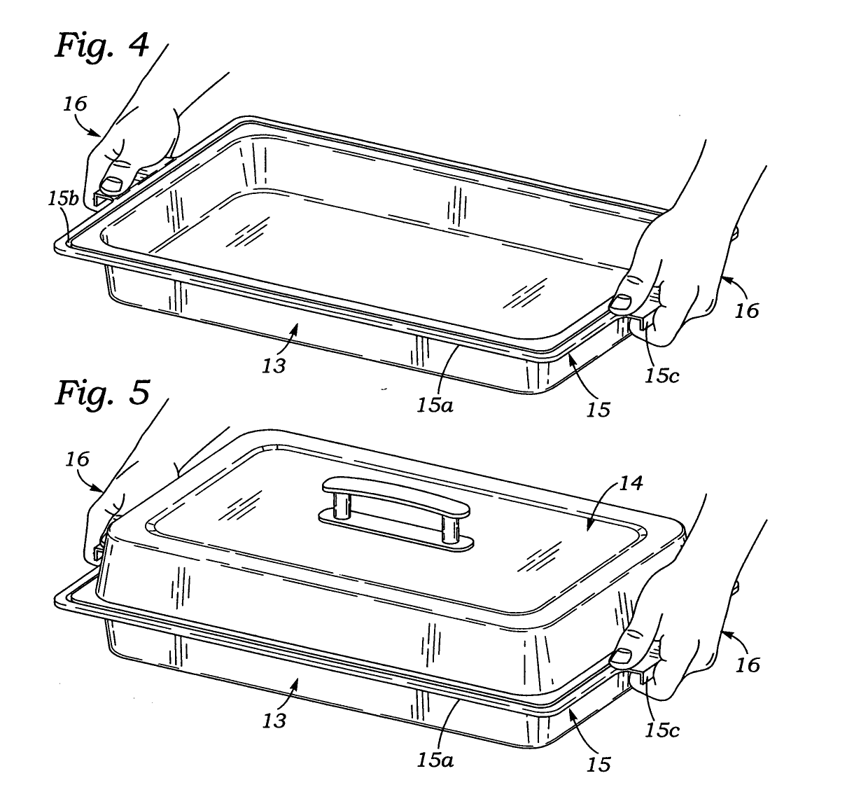

FIG. 4 illustrates the food pan 13 installed in the food pan carrier ring 15. It also shows how the rim 13a of the food pan rests on the top of the rim 15b of the food pan carrier ring. Also shown are hands 16 illustrating how the assembly would be transported.

FIG. 5 illustrates the food pan 13 along with the lid 14 installed in the food pan carrier ring 15. It also shows how the food pan rim 13a rests on the top of the rim of the food pan carrier ring 15b and how the rim of the lid 14a rests on the rim 15b of the food carrier ring. Also shown are hands 16 illustrating how the assembly would be transported.

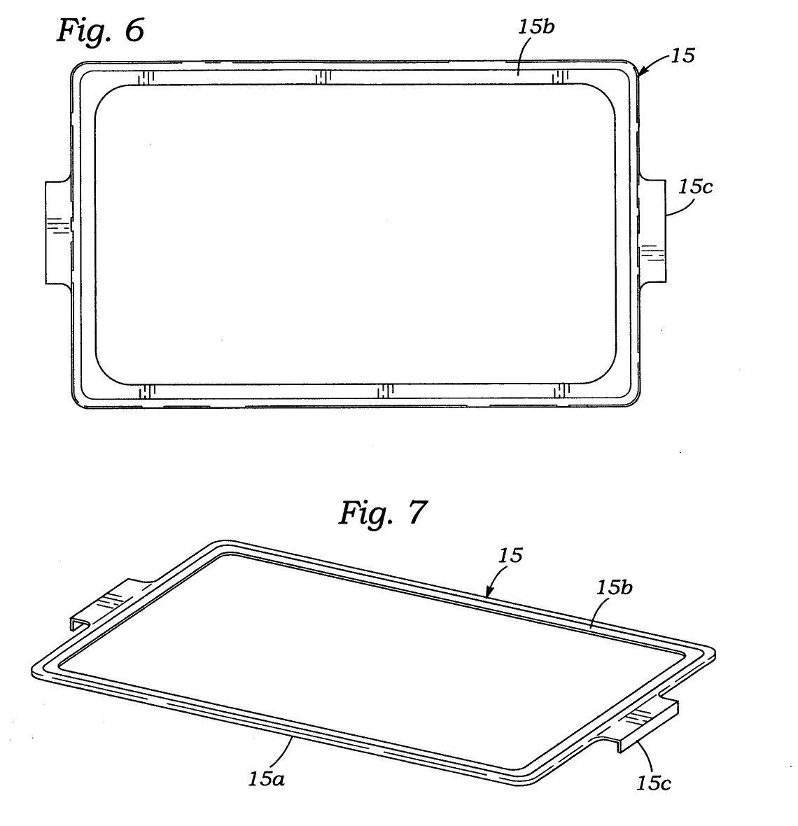

FIG. 6 is a plan view of the food pan carrier ring 15, the generally fitted bottom of the rim 15a and top of the rim 15b, and the handles 15c.

FIG. 7 is a perspective view of the food pan carrier ring 15, the generally fitted bottom of the rim 15a and top of the rim 15b, and the handles 15c.

While the principles of the invention have been described and illustrated in a single embodiment, it will be obvious to those skilled in the art that many modifications of structure, arrangement, proportions, materials, and components used in the practice of the invention can be particularly adapted for specific environments and operating requirements without departing from these principles.

What is claimed is:

1. A food pan carrier ring and a chafing dish assembly comprising:
a chafing dish frame for holding a hot water pan,
a food pan carrier ring configured to be placed on the rim of the hot water pan,
a hot food pan fitted within the food carrier ring,
a food carrier ring configured to hold a hot food pan,
a chafing dish lid configured to fit on the rim of the food pan carrier ring.

2. The food pan carrier ring comprising:
a food pan carrier ring configured to generally match the configuration of the rim of the hot water pan and generally lay over the rim;
a food pan carrier ring configured to generally match the configuration of the rim of the hot water pan, and configured to allow the insertion of a food pan with the interior of the ring,
a food pan carrier ring configured to sufficiently capture the rim of the hot food pan and transport it to a desired location.

3. The food pan carrier ring of claim 2 wherein:
said food pan carrier ring is configured to fit over the rim of the hot water pan;
said food carrier ring is configured to allow insertion of a food pan within the interior of the ring;
said food carrier ring is configured to slide up from the underside of the hot food pan such that the underside of the hot food pan rim rests on the top surface of the rim of the food pan carrier ring, and transported to a desired location,
said hot food pan carrier ring is configured to generally match the perimeter profile of the food pan.

4. The food carrier ring of claim 2 wherein:
said food carrier ring is sufficiently strong to carry the hot food pan
said food carrier ring is configured with handles
said food pan carrier ring can be lifted up under the rim of the hot water pan to capture the underside surface of the rim of the hot water pan and transported to the desired location.

5. A food pan carrier ring and chafing dish assembly comprising:
a chafing dish frame for holding a hot water pan;
a fitted food pan carrier ring configured to generally overlay the rim of the hot water pan;
a fitted food pan carrier ring configured to generally allow for insertion of a food pan within the interior of the ring and the said food pan along with the said food pan carrier ring inserted into the hot water pan;
a fitted food pan carrier ring configured to generally wrap around the perimeter of the said food pan;
a fitted food pan carrier ring generally configured to allow the underside surface of the food pan rim to rest on the top surface of the food pan carrier ring.

6. The food pan carrier ring of claim 5 wherein:
said food pan carrier ring is configured to match the profile of the rim of the hot water pan,
the interior of the said food pan carrier ring configured to match the side profile of the outer surface perimeter of the food pan, and
said top surface of the food carrier ring configured to match the profile of the top surface of the rim of the hot water pan,

7. A method for transporting hot food pans from the kitchen to the chafing dish. A food pan carrier ring capable of holding a hot food pan and comprising the steps of:
(a) setting the food carrier ring on the surface of a work table,
(b) placing the hot food pan over and within the interior of the carrier ring,
(c) if desired installing the lid over the hot food pan
(d) grasping the handles of the carrier ring and vertically lifting the ring until the bottom surface of the rim of the food pan rests on the top of the carrier ring,
(e) while holding the food pan within the carrier ring, transporting the hot food pan to the desired chafing dish location and setting the carrier ring along with the food pan and lid if installed into the chafing dish,
(f) leaving the carrier ring along with food pan in the chafing dish,
(g) serving the food until finished,
(h) removing the food pan from the carrier by grasping the handles of the food carrier ring, lifting the food pan and carrier ring out of the chafing dish along with the lid if installed and transporting it back to the kitchen, and
(g) repeating the stated method to bring additional food to the buffet line.
